(19) United States
(12) Patent Application Publication
(10) Pub. No.: US 2026/0323550 A1
(43) Pub. Date: Oct. 15, 2026

(54) A SECURE METHOD FOR WIRELESS COMMUNICATION DEVICES CHANGING A NETWORK DEVICE

(71) Applicant: QUALCOMM Incorporated, San Diego, CA (US)

(72) Inventors: Jie ZHANG, Shanghai (CN); Nicolas GRAUBE, Cambridge (GB); Anand Mohan SINGH, Ghaziabad (IN); Zaiyong CHEN, Shanghai (CN); Zhaoming YANG, Shanghai (CN); Yibo ZHAO, Shanghai (CN); Liuliu ZHAO, Shanghai (CN)

(21) Appl. No.: 19/482,136

(22) PCT Filed: Jun. 22, 2023
(86) PCT No.: PCT/CN2023/101993

§ 371 Date: Nov. 6, 2025

(51) Int. Cl. H04W 56/00; G09F 3/20; H04W 72/0446; H04W 88/08

(52) U.S. Cl. CPC H04W 56/0015; G09F 3/208; H04W 72/0446; H04W 88/08

(57) ABSTRACT

Disclosed are systems, apparatuses, processes, and computer-readable media for wireless communications. For example, a wireless communication device can receive, from a first network device of a plurality of network devices, a synchronization message comprising an indication of available response time slots for transmitting one or more unsolicited responses to the first network device. The wireless communication device can transmit, to the first network device, an unsolicited response in one of the available response time slots.

### FIELD OF THE DISCLOSURE

The present disclosure generally relates to wireless communications. For example, aspects of the present disclosure relate to systems and techniques for providing a secure method for wireless communication devices (e.g., peripheral devices, such as BLUETOOTH® (BT) electronic shelf labels (ESLs)) changing from one network device to another network device (e.g., from one access point (AP) to another AP).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for providing a secure method for wireless communication devices (e.g., peripheral devices) changing from one network device to another network device (e.g., from one access point (AP) to another AP). According to at least one illustrative example, a wireless communication device is provided for wireless communications. The wireless communication device includes at least one memory and at least one processor coupled to the at least one memory and configured to: receive, from a first network device of a plurality of network devices, a synchronization message comprising an indication of available response time slots for transmitting one or more unsolicited responses to the first network device; and outputting, for transmission to the first network device, an unsolicited response in one of the available response time slots.

In another illustrative example, a method of wireless communication performed at a wireless communication device is provided. The method includes: receiving, by the wireless communication device from a first network device of a plurality of network devices, a synchronization message comprising an indication of available response time slots for transmitting one or more unsolicited responses to the first network device; and transmitting, by the wireless communication device to the first network device, an unsolicited response in one of the available response time slots.

In another illustrative example, a non-transitory computer-readable storage medium is provided comprising instructions stored thereon which, when executed by at least one processor, causes the at least one processor to: receive, from a first network device of a plurality of network devices, a synchronization message comprising an indication of available response time slots for transmitting one or more unsolicited responses to the first network device; and outputting, for transmission to the first network device, an unsolicited response in one of the available response time slots.

In another illustrative example, an apparatus is provided for wireless communications. The apparatus includes: means for receiving, from a first network device of a plurality of network devices, a synchronization message comprising an indication of available response time slots for transmitting one or more unsolicited responses to the first network device; and means for transmitting, to the first network device, an unsolicited response in one of the available response time slots.

In another illustrative example, a network device is provided for wireless communications. The network device includes at least one memory and at least one processor coupled to the at least one memory and configured to: output, for transmission to a wireless communication device, a synchronization message comprising an indication of available response time slots for transmitting one or more unsolicited responses to the network device; and receive, from the wireless communication device, an unsolicited response in one of the available response time slots.

In another illustrative example, a method of wireless communication performed at a network device is provided. The method includes: transmitting, by the network device to a wireless communication device, a synchronization message comprising an indication of available response time slots for transmitting one or more unsolicited responses to the network device; and receiving, by the network device from the wireless communication device, an unsolicited response in one of the available response time slots.

In another illustrative example, a non-transitory computer-readable storage medium is provided comprising instructions stored thereon which, when executed by at least one processor, causes the at least one processor to: output, for transmission to a wireless communication device, a synchronization message comprising an indication of available response time slots for transmitting one or more unsolicited responses to the network device; and receive, from the wireless communication device, an unsolicited response in one of the available response time slots.

In another illustrative example, an apparatus is provided for wireless communications. The apparatus includes: means for transmitting, to a wireless communication device, a synchronization message comprising an indication of available response time slots for transmitting one or more unsolicited responses to the network device; and means for receiving, from the wireless communication device, an unsolicited response in one of the available response time slots.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a signaling diagram illustrating an example of communication transmissions between a network device and two groups of wireless communication devices, in accordance with some aspects of the present disclosure.

FIG. 5 is a diagram illustrating an example of an access protocol having three Asynchronous Connection-Oriented Link (ACL) time slots, in accordance with some aspects of the present disclosure.

FIG. 6 is a diagram illustrating an example associated with discovery and synchronization between access points, in accordance with some aspects of the present disclosure.

FIG. 7 is a diagram illustrating an example of signaling for wireless communication devices (e.g., ESLs) securely changing a network device (e.g., an AP), in accordance with some aspects of the present disclosure.

FIG. 8 is a diagram illustrating an example of a message that includes configuration data, in accordance with some aspects of the present disclosure.

FIG. 9 is a flow chart illustrating an example of a process for wireless communications, in accordance with some aspects of the present disclosure.

FIG. 10 is a block diagram illustrating an example of a computing system, which may be employed by the disclosed systems and techniques for wireless communication devices (e.g., ESLs) securely changing a network device (e.g., an AP), in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME), via at least one additional network entity, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME, each peripheral device (e.g., ESL) may have a wireless connection (e.g., a BLUETOOTH® Low Energy (BLE) connection or other connection) to AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

Each AP may have an associated channel map. A channel map is a listing of frequency channels to be utilized or, conversely, not to be utilized (e.g., in the context of modification of frequency hopping sequences) by an AP for communication, such as with the ESLs or other peripheral devices. While examples are described herein using ESLs as illustrative examples of wireless communication devices, a management entity as an example of a network entity, and access points as examples of network entities, the systems and techniques described herein are applicable to any type of system or network.

In ESL systems, periodic Advertisements (PAS) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

In some cases, an ESL may be physically moved to a new location. For example, the ESL may be moved from one location in a retail store (e.g., a particular shelf or a storage area) to a different location. Changing the location of the ESL may result in the ESL losing synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point.

To perform the onboarding procedure, the ESL may transmit advertisement messages (e.g., a connectable advertisement (CAP)), receive a connection request from an in-range access point (e.g., an access point that is within communication range) that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisements by one or more ESLs can result in spectral pollution on advertisement channels of the wireless network.

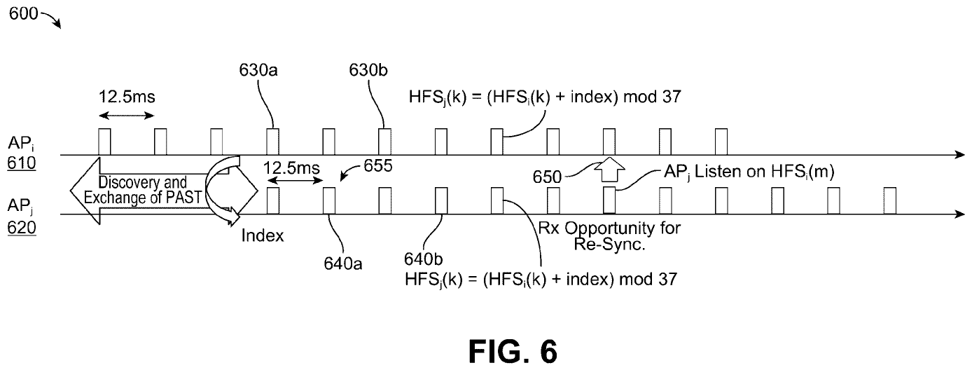

Currently, access point synchronization (e.g., described in detail in the description of FIG. 6) can enable discovery and synchronization of communication timings of multiple access points within an ESL system. In particular, periodic advertisement timings used by the multiple access points may be synchronized. In access point synchronization, an ESL can have access to multiple access points. When an ESL is moved from one location to another location such that the ESL is out of communications range of its current associated access point, the ESL can identify an alternative access point that is within communications range of the ESL to associate with and jump on a periodic advertisement with multiple responses (PAwMR) train associated with that access point.

The objective for access point synchronization is for all access points to transmit at the same time and to ensure that the overall spread of the transmission duration is within the ESL scan windows of time. It is advantageous to keep the transmission window of time as small as possible to conserve power resources. In an AP synchronized ESL system, an ESL can change access points using a PAwMR control message without needing to perform the traditional onboarding procedure (e.g., including CAP), which is time consuming and can introduce interference into the system.

However, when an ESL changes its location and, as a result, is out of communications range of its access point and needs to associate with another access point (e.g., an access point that is within communications range of the ESL and detected by the ESL), the ESL will need to exchange information with its management entity to complete the change AP procedure. Currently, a procedure for this exchange of information has not been defined.

In one or more examples, there may be many ESLs that need to change their respective access points at the same time (e.g., the many ESLs need to perform a change AP procedure at the same time). As such, the change AP procedure should be efficient and avoid the introduction of interference into the system. In one or more examples, every access point has its own AP key that it uses to generate a synchronization message (e.g., AP sync packets). When an ESL changes access points, the key for the new access point will need to be exchanged with the ESL in a secure way. As such, a change AP procedure that is secure, efficient, and avoids the introduction of additional interference into the system can be beneficial.

In one or more aspects of the present disclosure, systems, apparatuses, methods (also referred to as processes), and computer-readable media (collectively referred to herein as “systems and techniques”) are described herein that provide solutions for wireless communication devices (e.g., ESLs) to securely change from one network device (e.g., a first AP) to another network device (e.g., a second AP). In some aspects, secure and efficient systems and techniques are provided for a wireless communication device (e.g., ESL) changing to a new network device (e.g., the second AP) within a network device synchronized system (e.g., an AP synchronized ESL system).

In one or more aspects, in an environment where all network devices (e.g., APs) are synchronized with each other (e.g., as described in the description of FIG. 6), wireless communication devices (e.g., ESLs) can receive a synchronization message (e.g., an AP sync packets) from a network device (e.g., an AP that the ESLs detect and will change to). The synchronization message can include a bitmap that indicates available response time slots that the wireless communication devices (e.g., ESLs) can use to transmit responses (e.g., unsolicited responses) to the network device (e.g., AP). As used herein, an unsolicited response is a response that is not in reply to a periodic advertisement (e.g., a response other than a periodic advertisement response sent from an ESLs in reply to a periodic advertisement of a PAwMR train sent from an AP). Each of the wireless communication devices (e.g., ESLs) can determine which slot of the available slots from the bitmap to send (e.g., transmit) respective unsolicited responses to the network device (e.g., AP). The wireless communication devices (e.g., ESLs) can then send (e.g., transmit) their unsolicited responses on the available response time slots.

In one illustrative example, a wireless communication device (e.g., an ESL or other peripheral) can receive synchronization packets from one or more network devices for which the wireless communication device is not synchronized. When the wireless communication device determines to change from a first network device (e.g., a first AP) to a second network device (e.g., a second AP), the wireless communication device will need to try to synchronize with the second network device. For instance, as noted herein, the wireless communication device can determine to change from the first network device to the second network device (and thus to transmit an unsolicited response in one of the available response time slots to the second network device) based on determining the wireless communication device is out of communication range of the first network device. The wireless communication device can determine which slot of available slots from a bitmap to send (e.g., transmit) an unsolicited response with a change request (e.g., a change AP request) to the network device. The wireless communication device can then send the unsolicited response with the change request on the determined slot to the second network device. In some cases, the second network device can transmit the unsolicited response with the change request to a network entity (e.g., an ME). The network entity (e.g., the ME) can send (e.g., transmit) configuration data (e.g., identifier information, one or more keys for the second network device, etc.) to the wireless communication device that is changing from the first network device to the second network device. For instance, the network entity (e.g., the ME) can instruct the first network device (e.g., the first AP) to send a synchronization packet (e.g., an AP sync packet) including the configuration data to the wireless communication device. The wireless communication device can decrypt the key for the second network device using information stored on the wireless communication device (e.g., a syncing public key and a provisioning public key). The wireless communication device can send (e.g., transmit) a change confirmation message (e.g., a change AP confirmation) to the network entity (e.g., the ME) indicating that the wireless communication device has received (and/or has successfully decrypted) the configuration data for changing network devices and can be addressed on the second network device (e.g., the second AP). The wireless communication device can then attempt to synchronize with the second network device, such as by receiving one or more synchronization packets (e.g., AP sync packets) from the second network device. In some cases, the wireless communication device can decrypt information in the one or more synchronization packets using the decrypted key for the second network device.

Additional aspects of the present disclosure are described in more detail below.

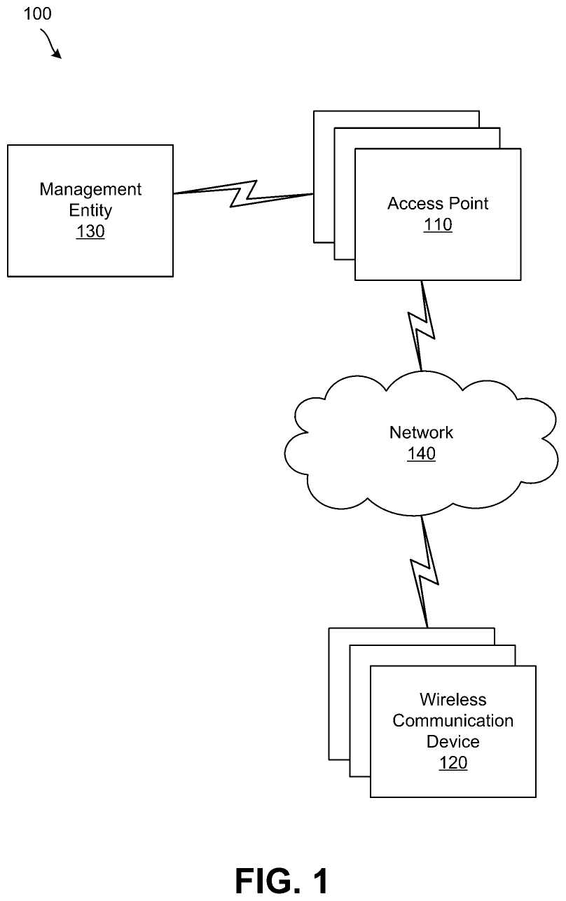

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or other device(s). The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

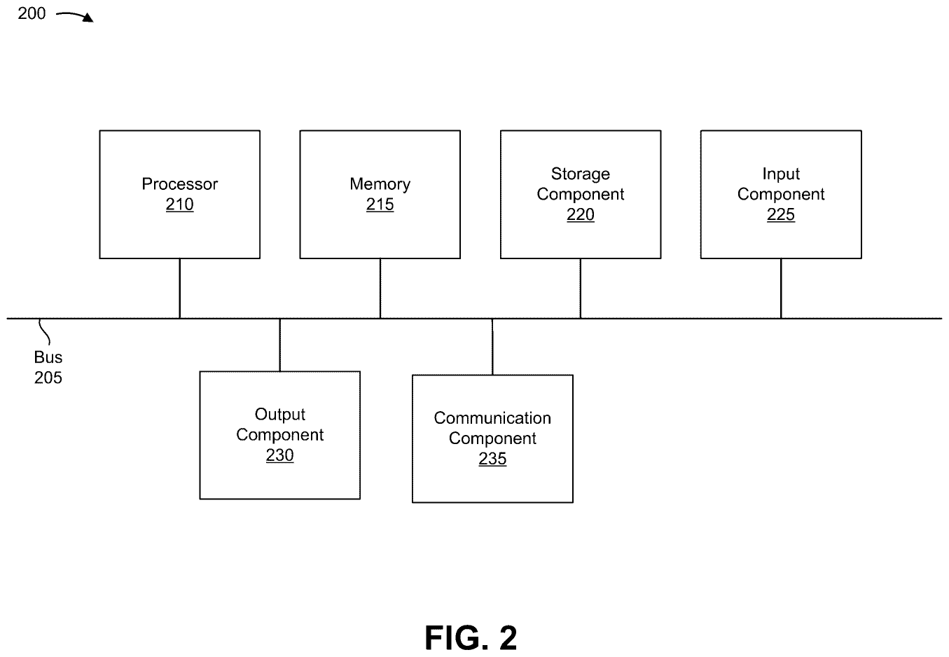

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

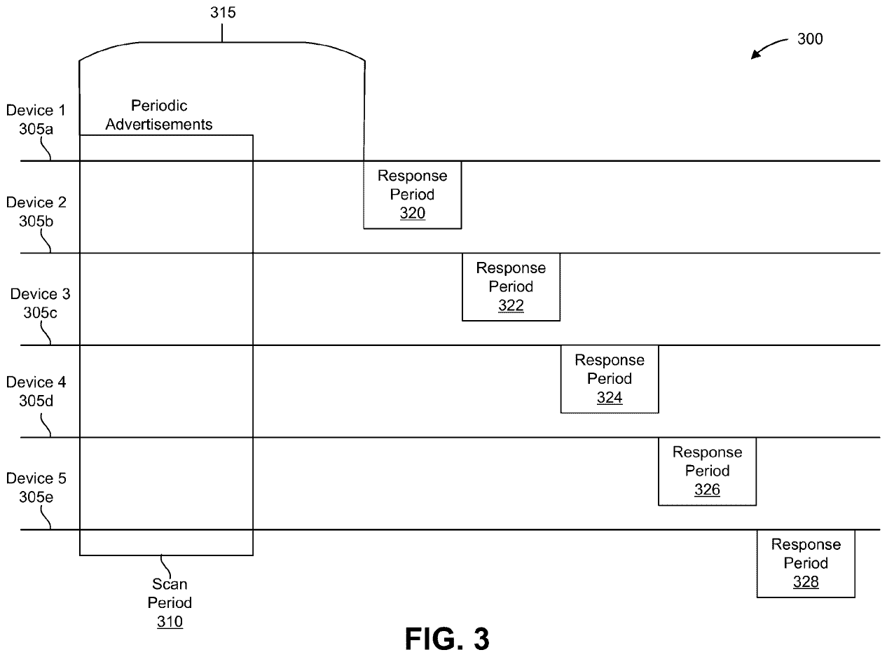

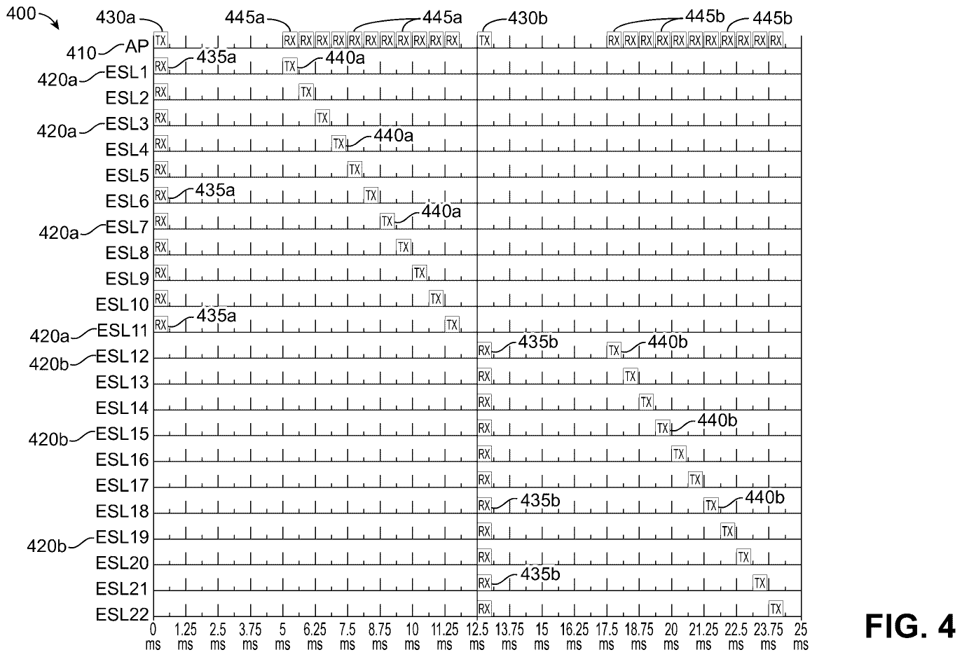

FIGS. 3 and 4 show signaling diagrams illustrating examples of PAwR in an ESL system. In particular, the signaling diagram of FIG. 3 shows an example PAwR for a group of wireless network devices (e.g., device 1 305a, device 2 305b, device 3 305c, device 4 305d, and device 5 305e), and the signaling diagram of FIG. 4 shows an example PAwR for two groups of wireless network devices 420a, 420b (e.g., a first group including ESL1 to ESL 11, and a second group including ESL 12 to ESL 22). Specifically, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, FIG. 4 shows an example PAwR for two groups of wireless network devices 420a, 420b (e.g., a first group including ESL1 to ESL 11, and a second group including ESL 12 to ESL 22). In particular, FIG. 4 is a signaling diagram illustrating an example of communication transmissions 400 between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective response time slots, the network device 410 can receive 445a their transmitted responses at those specific response slot times.

During operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective response time slots, the network device 410 can receive 445b their transmitted responses at those specific response slot times. The PAR may continue similarly for subsequent subframes of time.

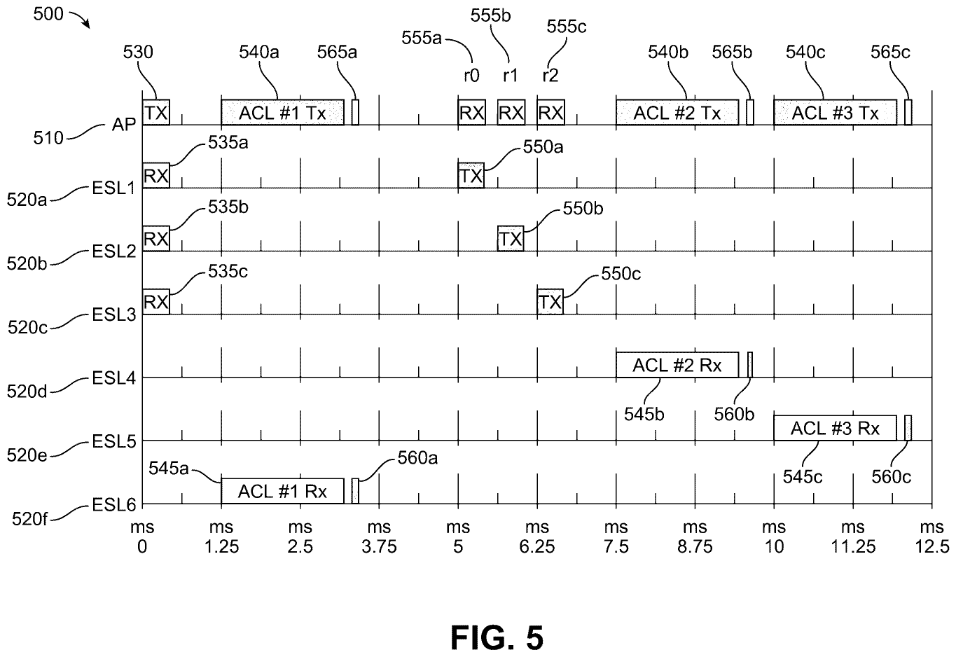

FIG. 5 is a diagram illustrating an example of an access protocol having three Asynchronous Connection-Oriented Link (ACL) (e.g., for a connection request or event) time slots (ACL1, ACL2, ACL3). In FIG. 5, the diagram is shown in the form of a graph 500 with an x-axis denoting time in milliseconds (ms) and a y-axis denoting a primary access point 510 (e.g., a network device) and specific wireless communication devices (e.g., ESL1 520a, ESL2 520b, ESL3 520c, ESL4 520d, ESL5 520e, and ESL6 520f). The wireless communication devices (e.g., ESL1 520a, ESL2 520b, ESL3 520c, ESL4 520d, ESL5 520e, and ESL6 520f) may be assigned to the primary access point 510. In particular, the x-axis of the graph of FIG. 5 denotes time starting from 0 ms and ending at 12.5 ms, which may represent a frame of time.

In FIG. 5, during operation for PAwR, at time 0 ms, the primary access point 510 may transmit 530 to the wireless communication devices (e.g., ESL1 520a, ESL2 520b, ESL3 520c, ESL4 520d, ESL5 520e, and ESL6 520f) a PA containing a synchronization message (e.g., an AP synchronization message) over a synchronized channel between the primary access point 510 and the wireless communication devices (e.g., ESL1 520a, ESL2 520b, ESL3 520c, ESL4 520d, ESL5 520e, and ESL6 520f). Also at time 0 ms, the wireless communication devices (e.g., ESL1 520a, ESL2 520b, ESL3 520c, ESL4 520d, ESL5 520e, and ESL6 520f) can receive 535a, 535b, 535c the PA containing the synchronization message over the synchronized channel.

In one or more examples, the primary access point 510 may be configured to transmit PAs at a specified time interval (e.g., a subframe of time), such as at every 12.5 ms as is shown in FIG. 5. In one or more examples, the specified time interval (e.g., a subframe) may be shorter or longer than the 12.5 ms as is shown in FIG. 5. The wireless communication devices (e.g., ESL1 520a, ESL2 520b, ESL3 520c, ESL4 520d, ESL5 520e, and ESL6 520f) may respond to a PA by using their specific respective response slot in time.

In one or more examples, the synchronization message transmitted 530 to the wireless communication devices (e.g., ESL1 520a, ESL2 520b, ESL3 520c, ESL4 520d, ESL5 520e, and ESL6 520f) may indicate a respective response slot for one or more of the wireless communication devices (e.g., ESL1 520a, ESL2 520b, ESL3 520c, ESL4 520d, ESL5 520e, and ESL6 520f) to use to transmit 550a, 550b, 550c a response to the primary access point 510. If a wireless communication device (e.g., ESL1 520a, ESL2 520b, ESL3 520c, ESL4 520d, ESL5 520e, and ESL6 520f) is addressed within the synchronization message, the wireless communication device (e.g., ESL1 520a, ESL2 520b, ESL3 520c, ESL4 520d, ESL5 520e, and ESL6 520f) can respond (e.g., transmit 550a, 550b, 550c) in its respective response slot, as indicated within the synchronization message. For example, the synchronization message may only address ESL1 520a, ESL2 520b, and ESL3 520c and, as such, only ESL1 520a, ESL2 520b, and ESL3 520c will transmit 550a, 550b, 550c a response to the primary access point 510.

After the wireless communication devices (e.g., ESL1 520a, ESL2 520b, ESL3 520c, ESL4 520d, ESL5 520e, and ESL6 520f) have received 535a, 535b, 535c the PA (via transmission 530) containing the synchronization message from the primary access point 510, according to the sequence specified within the synchronization message, the one or more wireless communication devices (e.g., ESL1 520a, ESL2 520b, and ESL3 520c) can transmit 550a, 550b, 550c their responses within their respective response slots. After the one or more wireless communication devices (e.g., ESL1 520a, ESL2 520b, and ESL3 520c) have transmitted 550a, 550b, 550c their responses in their respective response time slots, the primary access point 510 can receive 555a, 555b, 555c their transmitted responses at those specific response slot times.

Between the transmission 530 of the synchronization message by the primary access point 510 and the transmissions 550a, 550b, 550c of the responses from the one or more wireless communication devices (e.g., ESL1 520a, ESL2 520b, and ESL3 520c), the primary access point 510 can use a timeslot of an ACL1 link (shown as ACL #1 in FIG. 5) to transmit 540a data to ESL6 520f. After ESL6 520f receives 545a the data in the timeslot of the ACL1 link, the ESL6 520f may transmit 560a data with an acknowledgement response (e.g., in a data header of a packet including the data) to the primary access point 510. The primary access point 510 may then receive 565a the data including the acknowledgment response from the ESL6 520f.

A second ACL link (ACL2) may be scheduled by the primary access point 510 after receiving 555a, 555b, 555c the transmissions 550a, 550b, 550c of the responses from the one or more wireless communication devices (e.g., ESL1 520a, ESL2 520b, and ESL3 520c). The primary access point 510 may use a timeslot of the ACL2 link to transmit 540b data to ESL4 520d. After ESL4 520d receives 545b the data in the timeslot of the ACL2 link, the ESL4 520d may transmit 560b data with an acknowledgement response (e.g., in a data header of a packet including the data) to the primary access point 510. The primary access point 510 can then receive 565b the data including the acknowledgment response from the ESL4 520d.

After the second ACL link is scheduled by the primary access point 510, the primary access point 510 may schedule a third ACL link (ACL3). The primary access point 510 may use a timeslot of the ACL3 link to transmit 540c data to ESL5 520e. After ESL5 520e receives 545c the data in the timeslot of the ACL3 link, the ESL5 520e may transmit 560c data including an acknowledgement response (e.g., in a data header of a packet including the data) to the primary access point 510. The primary access point 510 can receive 565c the data with the acknowledgment response from the ESL5 520e.

FIG. 6 is a diagram illustrating an example of transmission timelines 600 associated with discovery and synchronization between access points (e.g., access points 110 of FIG. 1). As shown, example 300 includes access points (e.g., access points 110 of FIG. 1), shown as APᵢ 610 and APⱼ 620 on the transmission timelines 600. The access points APᵢ 610 and APⱼ 620 may be communicatively connected to a management entity (e.g., management entity 130 of FIG. 1). In some aspects, the access points and/or the management entity may be included in a wireless communication system, such as an ESL system. The wireless communication system may use a wireless communication technology, such as BLE.

As used herein, “transmission timing” or “periodic advertisement timing” may refer to a timing or schedule by which a device (e.g., an access point) transmits communications or periodic advertisements. For example, two devices that use (e.g., that are synchronized to) the same periodic advertisement timing may transmit periodic advertisements concurrently.

In one or more examples, during operation, a first access point AP1 (e.g., APi 610) may transmit (e.g., broadcast) periodic advertisements (e.g., PAs 630a, 630b), such as a train of periodic advertisements. The periodic advertisements may be unidirectional broadcast messages. The first access point AP1 may transmit periodic advertisements in accordance with a PAwMR schedule. Moreover, the first access point AP1 may transmit the periodic advertisements using a first hopping frequency sequence (HFS). The first HFS may be an HFS configured for the first access point AP1 (e.g., if the first access point AP1 is not a follower of another access point), or the first HFS may be different from a reference HFS based at least in part on a first index value associated with (e.g., selected by) the first access point AP1.

A second access point AP2 (e.g., APⱼ 620) may detect at least one periodic advertisement broadcast from the first access point AP1 (e.g., by scanning known channels on which the first access point AP1 performs transmissions and/or by scanning, or taking a snapshot of, an entire band). That is, the second access point AP2 may discover the first access point AP1. In some aspects, the second access point AP2 may listen on one or more advertisement channels (e.g., legacy advertisement channels) to detect information that enables the second access point AP2 to follow and synchronize with the first access point AP1, thereby enabling the second access point AP2 to monitor for the periodic advertisement(s) (e.g., PAs 630a, 630b). In some aspects, the second access point AP2 may monitor for (e.g., listen for) and detect the periodic advertisement(s) prior to initiation of periodic advertisement transmissions by the second access point AP2 (which may be referred to as a “detect before proceed” policy). For example, in a boot sequence during starting (or re-starting) of the second access point AP2, the second access point AP2 may listen for periodic advertisements from other access points before starting periodic advertisement transmissions. In some aspects, access points (e.g., isolated access points), such as the second access point AP2, may periodically listen for periodic advertisements from neighboring access points.

Based on detecting a periodic advertisement from the first access point AP1, the second access point AP2 may transmit, and the first access point AP1 may receive, a message (e.g., an unsolicited message) to initiate a connection between the first access point AP1 and the second access point AP2. Following the connection, or as part of the connection procedure, the first access point AP1 may transmit, and the second access point AP2 may receive, a synchronization message. The synchronization message may identify the periodic advertisement timing (e.g., the PAwMR schedule) used by the first access point AP1. For example, the synchronization message may include PAST information that indicates the periodic advertising timing used by the first access point AP1 (e.g., by indicating a time offset used by the first access point AP1). In some cases, the PAST information may also include the values of all of the parameters required for HFS computation as well as a channel map. In addition, or alternatively, the synchronization message may identify the first HFS used by the first access point AP1. For example, the PAST information may also indicate a reference HFS used by the first access point AP1, and the first HFS may be the reference HFS or an HFS that is shifted (e.g., frequency shuffled) from the reference HFS. For example, if an HFS is shifted from a reference HFS, then at all frequency instances in a frequency sequence, a channel index of the HFS may be different from a channel index of the reference HFS. In some aspects, the synchronization message may identify the first HFS used by the first access point AP1 by indicating the first index value associated with the first access point AP1 (e.g., the first HFS may be determined using the first index value and the reference HFS). For example, the synchronization message may indicate a set of index values that includes the first index value and/or one or more additional index values, associated with additional access points, known to the first access point AP1. In some aspects, the set of index values may include an index value for the second access point AP2 that indicates an HFS to be used by the second access point AP2.

The exchange of periodic advertising timing information (e.g., the exchange of PAST information) may enable the second access point AP2 to synchronize with the first access point AP1. Accordingly, in the same manner, multiple additional access points may synchronize to the same periodic advertisement timing. For example, a third access point AP3 may also synchronize with the first access point AP1, and a fourth access point AP4 may synchronize with the third access point AP3, thereby resulting in the fourth access point AP4 being synchronized with the second access point AP2 by transitive synchronization. In this way, multiple access points may become time synchronized with each other.

As shown by reference number 655, based on receiving the synchronization message, the second access point AP2 may transmit periodic advertisements (e.g., PAs 640a, 640b), such as transmissions on a data channel, synchronized with the periodic advertisement timing (e.g., the PAwMR schedule) used by the first access point AP1. In this way, periodic advertisements are transmitted concurrently by the first access point API and the second access point AP2. However, the second access point AP2 may transmit the periodic advertisements according to a second HFS. The second HFS may be offset from (e.g., different from) the first HFS used by the first access point AP1 or a reference HFS. In other words, each of the access points (e.g., with physically overlapping coverage areas) may use an HFS that is different from an HFS of any of the other access points. By using different HFSs, interference among the access points may be avoided despite the access points being time synchronized. As such, for any two HFSs of different APs, the probability of selecting the same channel at the same instant of time should be low.

The second HFS may be based at least in part on a second index value (e.g., different from the first index value) associated with the second access point AP2. For example, each of the access points (e.g., with physically overlapping coverage areas) may be associated with a different index value from any of the other access points. Accordingly, based at least in part on the set of index values identified to the second access point AP2, the second access point AP2 may select the second index value to achieve an HFS (e.g., in a radio frequency range of the second access point AP2) that is orthogonal to every other HFS currently in use. In some aspects, the second HFS may be shifted relative to the first HFS or the reference HFS based at least in part on the second index value. For example, the second HFS may be determined according to Equation 1 below:

HFSᵢ=(HFS₀+indexᵢ) mod 37 Equation 1
where HFS₀ is the reference HFS, HFSᵢ is the HFS being determined, and indexᵢ is the index value used to determine the HFS. Equation 1 uses a value of 37 for the modulo operation because a BLE system uses 37 data channels. However, a different value for the modulo operation may be used (e.g., corresponding to a quantity of channels) in other systems.

In some aspects, an index value may indicate an HFS in a manner other than as described above. That is, an index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

In some aspects, the first access point AP1 may transmit, and one or more wireless communication devices (e.g., wireless communication devices 120 of FIG. 1) may receive, information identifying the periodic advertisement timing (e.g., PAST information) used by the first access point AP1. For example, the first access point AP1 may transmit the information in connection with onboarding the wireless communication device(s) to the first access point AP1. In some aspects, the second access point AP2 may transmit, and one or more wireless communication devices (e.g., wireless communication devices 120) may receive, information identifying the periodic advertisement timing (e.g., PAST information) used by the second access point AP2. For example, the second access point AP2 may transmit the information to wireless communication devices already onboarded with the second access point AP2, or the second access point AP2 may cause the wireless communication devices to repeat an onboarding procedure with the second access point AP2 during which the information is transmitted.

In some aspects, the first access point AP1 may transmit (e.g., via broadcast), and one or more wireless communication devices (e.g., wireless communication devices 120 of FIG. 1) synchronized to the first access point AP1 may receive, information identifying a set of (e.g., one or more) index values indicating HFSs used by one or more access points. For example, the set of index values may include the first index value associated with the first access point AP1, the second index value associated with the second access point AP2, and/or one or more additional index values, associated with additional access points, known to the first access point AP1. Similarly, in some aspects, the second access point AP2 may transmit (e.g., via broadcast), and one or more wireless communication devices (e.g., wireless communication devices 120 of FIG. 1) synchronized to the second access point AP2 may receive, information identifying a set of (e.g., one or more) index values indicating HFSs used by one or more access points. For example, the one or more index values may include the first index value associated with the first access point AP1, the second index value associated with the second access point AP2, and/or one or more additional index values, associated with additional access points, known to the second access point AP2. In some aspects, the first access point AP1 and/or the first access point AP1 may receive, from the management entity, information indicating the index values that are in use (e.g., valid indexes) for one or more additional access points.

Over time (e.g., due to clock drift), the periodic advertisement timing used by the first access point AP1 and the second access point AP2 may become misaligned. As shown by reference number 650, the second access point AP2 may monitor (e.g., sporadically) for an additional periodic advertisement from the first access point AP1 in a monitoring opportunity. In other words, the second access point AP2 may sacrifice a periodic advertisement transmission (e.g., for a particular group of wireless communication devices) in order to monitor (e.g., listen) for the additional periodic advertisement from the first access point AP1. In some aspects, the monitoring opportunity, in which the second access point AP2 monitors for the additional periodic advertisement, may be based at least in part on an expected clock drift between the first access point AP1 and the second access point AP2. Based on a timing of the additional periodic advertisement, the periodic advertisement timing may be realigned between the first access point AP1 and the second access point AP2. For example, the second access point AP2 may realign with the periodic advertisement timing used by the first access point AP1 based at least in part on a timing of the additional periodic advertisement (e.g., based at least in part on a difference between the actual timing of the additional periodic advertisement and an expected timing of the additional periodic advertisement).

In some examples, an access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point. Thus, in this example, the second access point is both a leader access point and a follower access point.

As indicated above, FIG. 6 is provided as an example. Other examples may differ from what is described with respect to FIG. 6.

As previously mentioned, in some cases, an ESL may be physically moved to a new location. The ESL, for example, may be moved from one location in a retail store (e.g., a particular shelf or a storage area) to a different location in the retail store. The changing of the location of the ESL can result in the ESL losing synchronization with (e.g., due to being out of communications range) a current AP for which the ESL is associated. Such a loss in synchronization can interrupt the management entity's (ME's) ability to control the ESL, and the ESL's ability to report to the management entity. After determining a network outage (e.g., caused by the loss of synchronization), the ESL can perform an onboarding procedure to reestablish synchronization with an AP.

To perform the onboarding procedure, the ESL can transmit advertisement messages (e.g., a CAP), receive a connection request from an in-range AP that detected the advertisement messages, and exchange messages with the AP (e.g., including the exchange of PAST information). The onboarding procedure can consume a significant amount of computing resources (e.g., processor resources, memory resources, and/or battery resources, among other examples) of the ESL and/or the AP, and frequent advertisements by one or more ESLs can result in spectral pollution on advertisement channels of the wireless network.

Currently, AP synchronization (e.g., previously described in detail in the description of FIG. 6) can enable discovery and synchronization of communication timings of multiple APs within an ESL system. In particular, periodic advertisement timings used by the multiple APs can be synchronized. In AP synchronization, an ESL may have access to multiple APs. When an ESL is moved from one location to another location (e.g., within a store) such that the ESL is out of communications range of its current associated AP, the ESL can identify an alternative AP that is located within communications range of the ESL to associate with and jump on a PAwMR train associated with that AP.

The objective for AP synchronization is for all APs to transmit at the same time and to ensure that the overall spread of the transmission duration is within the ESL scan windows of time. It is beneficial to keep the transmission window of time as small as possible to conserve the power resources. In an AP synchronized ESL system, an ESL can change APs using a PAwMR control message without needing to perform the traditional onboarding procedure (e.g., including CAP), which can be time consuming and may introduce interference into the system.

However, when an ESL changes its location and, as a result, is out of communications range of its associated AP and needs to associate with another AP (e.g., an AP that is within communications range of the ESL and detected by the ESL), the ESL will need to exchange information with its management entity to complete the change AP procedure.

In one or more examples, there can be cases where many ESLs need to change their respective APs at the same time (e.g., the many ESLs need to perform a change AP procedure at the same time). As such, the change AP procedure needs to be efficient and avoid the introduction of interference into the system. In one or more examples, every AP has its own associated AP key that the AP uses to generate a synchronization message (e.g., AP sync packets). When an ESL changes APs, the key for the new AP will need to be exchanged with the ESL in a secure way. A change AP procedure that is secure, efficient, and avoids the introduction of additional interference into the system can be very useful.

In one or more aspects, the systems and techniques provide solutions for wireless communication devices (e.g., ESLs) to securely change a network device (e.g., an AP). In some aspects, secure and efficient systems and techniques are provided for a wireless communication device (e.g., ESL) changing a network device (e.g., AP) within a network device synchronized system (e.g., an AP synchronized ESL system).

In one or more examples, in an environment where all network devices (e.g., APs) are synchronized with each other (e.g., as previously described in the description of FIG. 6), wireless communication devices (e.g., ESLs) may receive a synchronization message (e.g., an AP sync packets) from a network device (e.g., an AP that the ESLs can detect and can change to). The synchronization message (e.g., AP sync packets) may include a bitmap that indicates available response time slots that the wireless communication devices (e.g., ESLs) may use to send (e.g., transmit) responses to the network device (e.g., AP). Each of the wireless communication devices (e.g., ESLs) can determine which slot of the indicated available slots to send (e.g., transmit) their unsolicited response to the network device (e.g., AP). The wireless communication devices (e.g., ESLs) may then send (e.g., transmit) their unsolicited responses on the available response time slots.

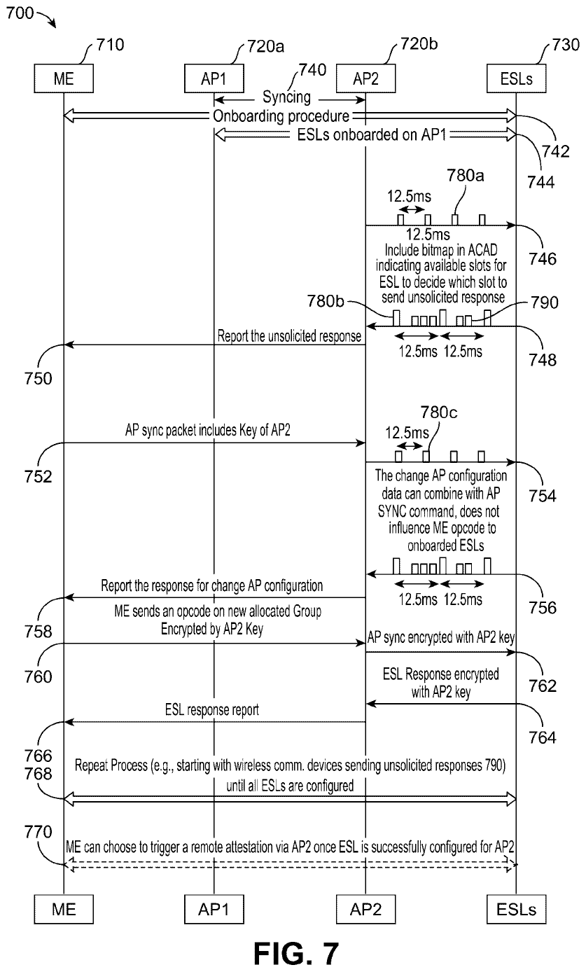

FIG. 7 shows an example of signaling that may be employed for the disclosed systems and techniques for one or more wireless communication devices (e.g., ESLs) changing a network device (e.g., AP) within a network device synchronized system (e.g., an AP synchronized ESL system). In particular, FIG. 7 is a diagram illustrating an example of signaling 700 for one or more wireless communication devices (e.g., ESLs 730) securely changing a network device (e.g., from AP 1 720a to AP 2 720b). In FIG. 7, a system that can utilize the signaling 700 is shown to include a network entity (e.g., management entity 710, such as management entity 130 of FIG. 1), network devices (e.g., AP 1 720a and AP 2 720b, such as access points 110 of FIG. 1), and one or more wireless communication devices (e.g., ESLs 730, such as wireless communication devices 120 of FIG. 1). In one or more examples, the system may include more network entities, more network devices, and/or more wireless communication devices than are shown in FIG. 7.

During operation of the system, the network devices (e.g., AP 1 720a, AP 2 720b) within the system can be synchronized (e.g., synching 740) with each other (e.g., by utilizing the procedure described in the description of FIG. 6).

One or more wireless communication devices (e.g., ESLs 730), which are within communications range of a first network device (e.g., AP 1 720a), can perform an onboarding procedure 742, 744 to associate with the first network device (e.g., AP 1 720a) via the network entity (e.g., management entity 710). During the onboarding procedure 742, 744, the network entity (e.g., management entity 710) can generate a random private public syncing key pair for the one or more of the onboarded wireless communication devices (e.g., ESLs 730). During the onboarding procedure, the network entity (e.g., management entity 710) can also write a syncing public key for the one or more of the wireless communication devices (e.g., ESLs 730) via a generate attribute profile (GATT), such as a GATT_write( ).

The one or more wireless communication devices (e.g., ESLs 730), which are associated with the first network device (e.g., AP 1 720a), have changed location, and are no longer within communications range of the first network device (e.g., AP 1 720a). The one or more wireless communication devices (e.g., ESLs 730) are now within communications range of a second network device (e.g., AP 2 720b).

The second network device (e.g., AP 2 720b) can transmit (e.g., broadcast) a train 746 (e.g., PA train) of synchronization messages 780a (e.g., AP sync packets). In some examples, a synchronization message 780a can be transmitted in the train 746 every 12.5 milliseconds (ms). In one or more examples, each synchronization message 780a can include a bitmap (e.g., in an Additional Controller Advertising Data (ACAD) field). The bitmap can indicate available response time slots for the one or more wireless communication devices (e.g., ESLs 730) to send (e.g., transmit) unsolicited responses, when the one or more wireless communication devices (e.g., ESLs 730) want to associate with the second network device (e.g., AP 2 720b). In one or more examples, the available response time slots for the unsolicited responses will be located in between the transmissions of the synchronization messages 780a.

The one or more wireless communication devices (e.g., ESLs 730), which are within communications range of the second network device (e.g., AP 2 720b) can receive the synchronization messages 780a that are transmitted at every 12.5 ms. When the one or more wireless communication devices (e.g., ESLs 730) determine to associate with the second network device (e.g., AP 2 720b), such as based on no longer being within communications range of the first network device (e.g., AP 1 720a), each of the one or more wireless communication devices (e.g., ESLs 730) can determine which available response time slot (e.g., as indicated within the bitmap) to send (e.g., transmit) unsolicited response 790 (e.g., a change network device request). The one or more wireless communication devices (e.g., ESLs 730) can then send (e.g., transmit) unsolicited responses 790 (e.g., as shown in the PAwMR train 748 that includes a synchronization message 780b) in a respective available response time slot.

In one or more examples, the one or more wireless communication devices (e.g., ESLs 730) can continuously send (e.g., transmit) the unsolicited responses 790, until a timeout has occurred (e.g., a predetermined duration of time has lapsed). When a timeout for the one or more wireless communication devices (e.g., ESLs 730) has occurred and the one or more wireless communication devices (e.g., ESLs 730) have not yet received a change in network device configuration data (e.g., such as within train 754), the one or more wireless communication devices (e.g., ESLs 730) can cease (stop) transmitting the unsolicited responses 790, try to associate with another network device (e.g., AP 3) that is within communication range, and/or enter CAP to indicate a loss of synchronization with the network entity (e.g., management entity 710).

After the second network device (e.g., AP 2 720b) receives the unsolicited responses 790 from the one or more wireless communication devices (e.g., ESLs 730), the second network device (e.g., AP 2 720b) can send (e.g., transmit) a report 750 of the received unsolicited responses 790 to the network entity (e.g., management entity 710).

After the network entity (e.g., management entity 710) receives the report 750 from the second network device (e.g., AP 2 720b), the network entity (e.g., management entity 710) can generate a shared secret using the syncing public key and the provisioning public key for the one or more wireless communication devices (e.g., ESLs 730). The network entity (e.g., management entity 710) can then derive an encryption key from the shared secret. The network entity (e.g., management entity 710) can encrypt, using the derived encryption key, the second network device's (e.g., AP 2 720b) key and a new group identifier (GID) and/or ESL identifier (EIID). The EIID for an ESL can include or be based on a GID of a group to which the ESL is assigned and an identifier (EID) assigned to the ESL (e.g., a unique identifier for the ESL within the group corresponding to the GID). For example, the EIID can be a combination of the GID and the EID of the ESL.

The network entity (e.g., management entity 710) can send a message 752 (e.g., an AP sync packet) including change network device configuration data to the second network device (e.g., AP 2 720b). The change network device configuration data can include the encrypted key of the second network device (e.g., AP 2 720b) and the encrypted GID and/or EIID.

After the second network device (e.g., AP 2 720b) receives the message 752, the second network device (e.g., AP 2 720b) can transmit (e.g., broadcast) a train 754 (e.g., PA train) of synchronization messages 780c (e.g., AP sync packets). In one or more examples, a synchronization message 780c can be transmitted in the train 754 every 12.5 milliseconds (ms). One or more synchronization messages 780c can include the change in network device configuration data. In one or more examples, the change in network device configuration data can combine with the synchronization command (e.g., AP sync command) within the synchronization message 780c such that the change in network device configuration data does not influence the network entity's (e.g., management entity's 710) operational code (e.g., OpCode) to the onboarded wireless communication devices (e.g., ESLs 730).

After the one or more wireless communication devices (e.g., ESLs 730) receive the synchronization messages 780c every 12.5 ms, the one or more wireless communication devices (e.g., ESLs 730) will have the change in network device configuration data, which includes the encrypted second network device's (e.g., AP 2 720b) key and the encrypted GID and/or EIID. Upon the successful receipt of the change in network device configuration data, the one or more wireless communication devices (e.g., ESLs 730) can send (e.g., transmit) a response (e.g., a change of network device confirmation) on any available response time slots.

In order to send (e.g., transmit) the responses (e.g., change of network device confirmations), the one or more wireless communication devices (e.g., ESLs 730) can first generate a shared secret using the syncing public key and the provisioning private key for the one or more wireless communication devices (e.g., ESLs 730). The one or more wireless communication devices (e.g., ESLs 730) can then derive an encryption key from the shared secret. One or more wireless communication devices (e.g., ESLs 730) can decrypt, using the derived encryption key, the encrypted second network device's (e.g., AP 2 720b) key and the encrypted GID and/or EIID. The one or more wireless communication devices (e.g., ESLs 730) can then replace the first network device's (e.g., AP 1 720a) key for the second network device's (e.g., AP 2 720b) key. As such, this encryption/decryption procedure provides a secure way for the network entity (e.g., management entity 710) and the one or more wireless communication devices (e.g., ESLs 730) to exchange a new network device key (e.g., an AP 2 720b key). The one or more wireless communication devices (e.g., ESLs 730) can also listen on the newly assigned GID and/or EIID.

The one or more wireless communication devices (e.g., ESLs 730) can send (e.g., transmit) the responses (e.g., change of network device confirmations) on any available response time slots (e.g., as shown in the PAwMR train 756). In one or more examples, the one or more wireless communication devices (e.g., ESLs 730) can continuously send (e.g., transmit) the responses (e.g., a change of network device confirmations), until a timeout has occurred (e.g., a predetermined duration of time has lapsed). When a timeout for the one or more wireless communication devices (e.g., ESLs 730) has occurred and the one or more wireless communication devices (e.g., ESLs 730) have not yet received an encrypted operational code (e.g., such as within synchronization message 762), the one or more wireless communication devices (e.g., ESLs 730) can cease (stop) transmitting the responses, try to associate with another network device (e.g., AP 3) that is within communication range, and/or enter CAP to indicate a loss of synchronization with the network entity (e.g., management entity 710).

After the second network device (e.g., AP 2 720b) receives the responses (e.g., the change of network device confirmations) from the one or more wireless communication devices (e.g., ESLs 730), the second network device (e.g., AP 2 720b) can send (e.g., transmit) a report 758 of the received responses to the network entity (e.g., management entity 710). After the network entity (e.g., management entity 710) receives the report 758, the network entity (e.g., management entity 710) can review the report 758 to determine which wireless communication devices (e.g., ESLs 730) are successfully configured for the new network device (e.g., AP 2 720b).

Once the network entity (e.g., management entity 710) determines which wireless communication devices (e.g., ESLs 730) are successfully configured, the network entity (e.g., management entity 710) can generate a message 760. The message 760 can include an encrypted operational code (OpCode) for the successfully configured wireless communication devices (e.g., ESLs 730). The encrypted OpCode may be encrypted by the network entity (e.g., management entity 710) using the second network device key (e.g., an AP 2 720b key). The network entity (e.g., management entity 710) can send (e.g., transmit) the message 760 to the second network device (e.g., AP 2 720b).

After the second network device (e.g., AP 2 720b) receives the message 760 (e.g., including the encrypted OpCode), the second network device (e.g., AP 2 720b) can transmit (e.g., broadcast) a synchronization message 762 (e.g., AP sync packets), which includes the encrypted OpCode, to the one or more wireless communication devices (e.g., ESLs 730).

Upon receiving the synchronization message 762 (e.g., AP sync packets), the one or more wireless communication devices (e.g., ESLs 730) can decrypt the encrypted OpCode using the second network device key (e.g., an AP 2 720b key). After the one or more wireless communication devices (e.g., ESLs 730) receive the synchronization message 762 (e.g., AP sync packets), the one or more wireless communication devices (e.g., ESLs 730) can also cease (stop) sending (transmitting) the responses (e.g., change of network device confirmations), as shown in the PAwMR train 756.

The one or more wireless communication devices (e.g., ESLs 730) can also send (e.g., transmit) a response 764, which may be encrypted using the second network device key (e.g., an AP 2 720b key), to the second network device (e.g., AP 2 720b). The response 764 can include a confirmation of receipt of the encrypted OpCode. After the second network device (e.g., AP 2 720b) receives the response 764, the second network device (e.g., AP 2 720b) can send (e.g., transmit) to the network entity (e.g., management entity 710) a response report 766 indicating that the one or more wireless communication devices (e.g., ESLs 730) successfully received the encrypted Opcode.

After the network entity (e.g., management entity 710) receives the response report 766, the network entity (e.g., management entity 710) can review the response report 766 and record the change of network device (e.g. AP) status for the one or more wireless communication devices (e.g., ESLs 730) that have successfully received the encrypted Opcode, as indicated in the response report 766.

In one or more examples, the process repeats at operation(s) 768 (e.g., starting again when the one or more wireless communication devices send their unsolicited responses 790, as shown in the PAwMR train 748) several times (e.g., three to seven times), until all of the one or more wireless communication devices (e.g., ESLs 730) have been successfully configured to be associated with the second network device (e.g., AP 2 720b). In some examples, the network entity (e.g., management entity 710) can determine to trigger a remote attestation 770 via the second network device (e.g., AP 2 720b), when one or more wireless communication devices (e.g., ESLs 730) have been successfully configured to be associated with the second network device (e.g., AP 2 720b).

In one or more aspects, as previously mentioned, the second network device (e.g., AP 2 720b) can transmit (e.g., broadcast) a train 754 (e.g., PA train) of synchronization messages 780c (e.g., AP sync packets), where each synchronization message 780c can be transmitted in the train 754 every 12.5 milliseconds (ms). A synchronization message 780c can include the change in network device configuration data, which can include the new network device's (e.g., AP 2's 720b) key. The change in network device configuration data can combine with the synchronization command (e.g., AP sync command) within the synchronization message 780c such that the change in network device configuration data will not influence the network entity's (e.g., management entity's 710) operational code (e.g., OpCode) to the onboarded wireless communication devices (e.g., ESLs 730). In one or more examples, the change in network device configuration data can be included in the synchronization messages 780c (e.g., AP sync packets) within the payload data 820 of an AUX SYNC_SUBEVENT_IND command.

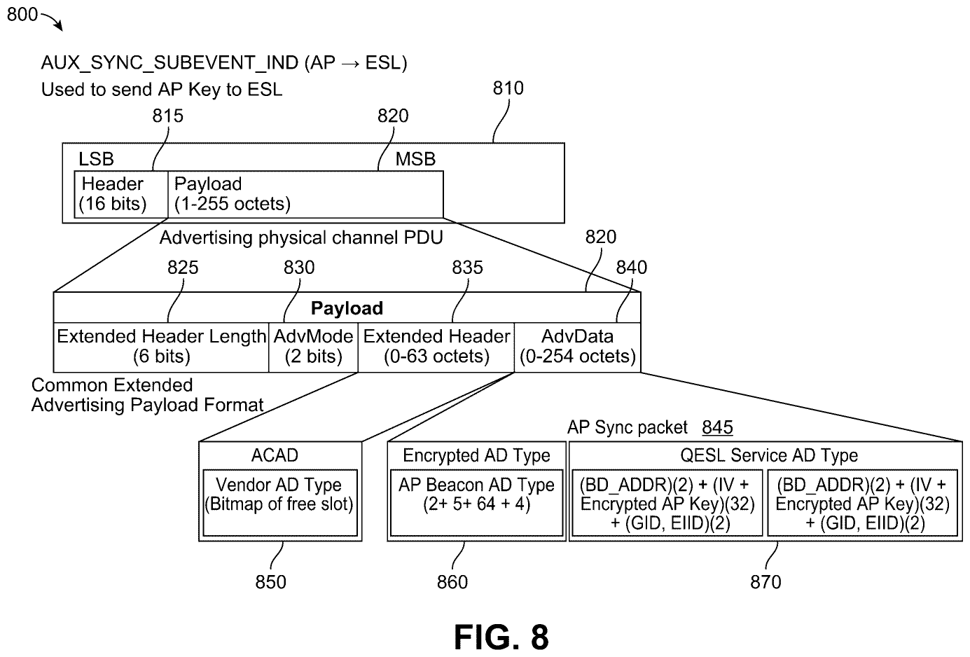

FIG. 8 shows an example of where the change in network device (e.g., AP) configuration data can be included within the synchronization messages 780c (e.g., AP sync packets). In particular, FIG. 8 is a diagram illustrating an example of a message 800 that includes configuration data (e.g., a change in network device configuration data). In FIG. 8, the message 800 is shown to include an AUX_SYNC_SUBEVENT_IND command. The structure of the AUX_SYNC_SUBEVENT_IND command is shown to include an advertising physical channel protocol data unit (PDU) 810. The advertising physical channel PDU 810 includes a header 815 (e.g., including 15 bits) and a payload 820 (e.g., of 1 to 255 octets).

The payload 820 includes an extended header length 825 (e.g., 6 bits), an advanced mode (AdvMode) 830 (e.g., 2 bits), another extended header 835 (e.g., of 0 to 63 octets), and advanced data (AdvData) 840 (e.g., of 0 to 254 octets). The extended header 835 includes ACAD 850. The Adv Data 840 includes the AP sync packet 845 (e.g., synchronization message). The AP sync packet 845 includes an encrypted AD type 860 and a service AD type 870. In one or more examples, configuration data (e.g., a change in network device configuration data) may be included within the service AD type 870.

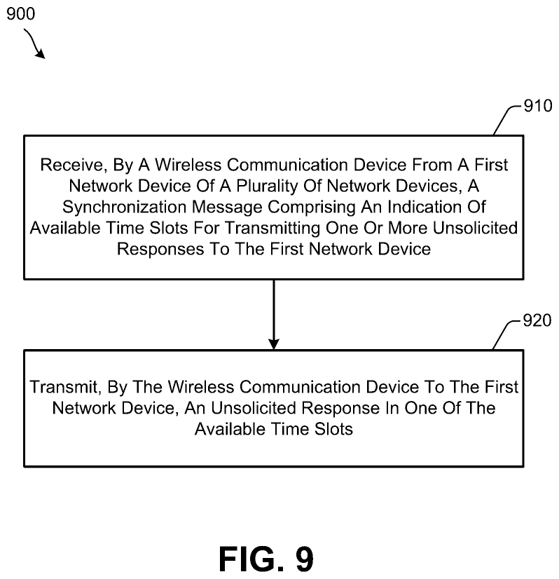

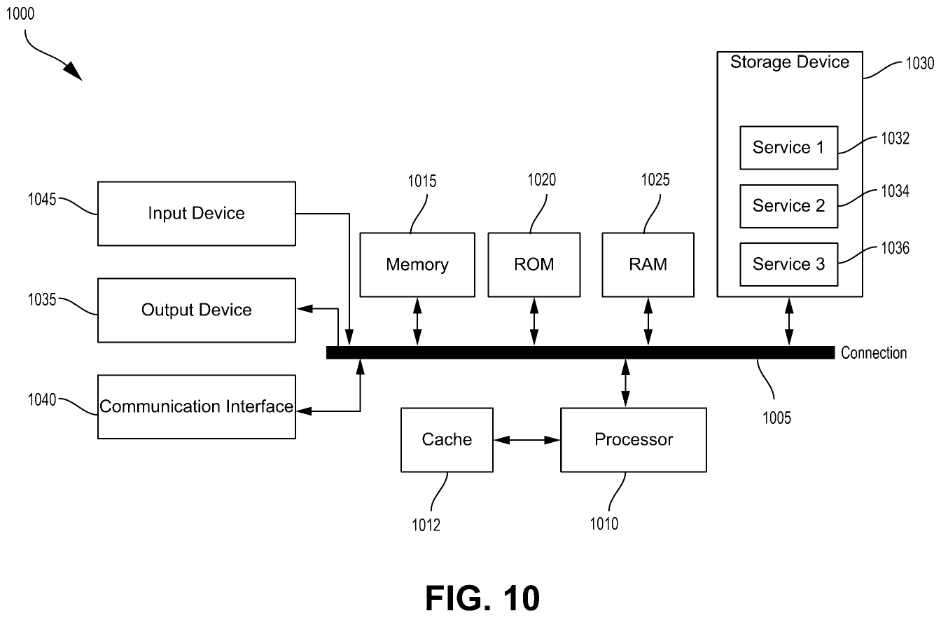

FIG. 9 is a flow chart illustrating an example of a process 900 for wireless communications utilizing methods for wireless communication devices (e.g., ESLs) to securely change from one network device to another network device (e.g., from a first AP to a second AP). The process 900 can be performed by a wireless communication device (e.g., device 200 of FIG. 2, device 1 305a or other device of FIG. 3, network device 420a or other network device of FIG. 4, ESL 1 520a or other ESL of FIG. 5, an ESL from the ESLs 730 of FIG. 7) or by a component or system (e.g., a chipset) of the wireless communication device. The operations of the process 900 may be implemented as software components that are executed and run on one or more processors (e.g., processor 210 of FIG. 1, processor 1010 of FIG. 10, and/or other processor(s)). Further, the transmission and reception of signals by the wireless communications device in the process 900 may be enabled, for example, by one or more antennas and/or one or more transceivers such as one or more wireless transceivers (e.g., communication component 235 of FIG. 2, communication interface 1040 of FIG. 10, and/or other antenna and/or transceiver(s)).

At block 910, the wireless communication device (or component thereof) can receive, from a first network device of a plurality of network devices, a synchronization message comprising an indication of available response time slots for transmitting one or more unsolicited responses to the first network device. In some cases, the first network device is an access point (AP) (e.g., AP2 720b of FIG. 7 or other AP). In other cases, the first network device is a management entity (e.g., the ME 710 of FIG. 7). In some aspects, the synchronization message includes a bitmap that includes the indication of the available response time slots. The wireless communication device (or component thereof) can determine the one of the available response time slots to transmit the unsolicited response from the bitmap.

Referring to FIG. 7 as an illustrative example, the AP 2 720b can transmit (e.g., broadcast) a train 746 (e.g., a PA train) of synchronization messages 780a. As noted above, the synchronization messages 780a can be AP sync packets in some cases. In some examples, each synchronization message 780a can include a bitmap (e.g., in an Additional Controller Advertising Data (ACAD) field) that indicates available response time slots for the one or more wireless communication devices (e.g., ESLs 730) to transmit unsolicited responses. In some cases, the available response time slots for the unsolicited responses can be located in between the transmissions of the synchronization messages 780a.

At block 920, the wireless communication device (or component thereof) can transmit an unsolicited response in one of the available response time slots. In some aspects, the wireless communication device is synchronized with a second network device (e.g., the AP1 720a of FIG. 7). In such aspects, the wireless communication device (or component thereof) can determine the wireless communication device is out of communication range of the second network device (e.g., the AP1 720a of FIG. 7). The wireless communication device (or component thereof) can transmit the unsolicited response in one of the available response time slots to the first network device based on determining the wireless communication device is out of communication range of the second network device.

Referring again to FIG. 7 as an illustrative example, an ESL from the ESLs 730 is within communications range of the AP 2 720b and can receive the synchronization messages 780a (e.g., transmitted at every 12.5 ms or with other periodicity). Upon determining to associate with the AP 2 720b (e.g., based on being out of communication range of the AP 1 720a), the ESL can determine which available response time slot (e.g., as indicated within the bitmap) to transmit an unsolicited response 790 (e.g., which can include a change network device request). The ESL can then transmit the unsolicited response 790 (e.g., as shown in the PAwMR train 748 that includes a synchronization message 780b) in a respective available response time slot.

In some aspects, the wireless communication device (or component thereof) can receive, from the first network device, configuration data associated with the first network device. The configuration data can include an encrypted key for the first network device, an identifier associated with the first network device, and/or other information. The identifier can be an EIID, which as described above can be based on a group identifier (GID) of a group to which the wireless communication device is assigned and an identifier (EID) assigned to the wireless communication device.

In some cases, the wireless communication device (or component thereof) can decrypt, by the wireless communication device, the encrypted key for the first network device to generate a key for the first network device. The wireless communication device (or component thereof) can replace a key for the second network device (e.g., the AP1 720a of FIG. 7) with the key for the first network device.

In some aspects, the wireless communication device (or component thereof) can receive one or more synchronization packets (e.g., message 752 of FIG. 7, which can be a synchronization packet, such as an AP sync packet) from the first network device (e.g., AP 2 720b of FIG. 7). The one or more synchronization packets are encrypted using the key for the first network device (e.g., the key of AP 2 720b of FIG. 7). The wireless communication device (or component thereof) can decrypt information from the one or more synchronization packets using the key for the first network device. The wireless communication device (or component thereof) can further synchronize with the first network device (e.g., AP 2 720b of FIG. 7) using the decrypted information from the one or more synchronization packets.

In some aspects, the wireless communication device (or component thereof) can transmit, to a network entity (e.g., the ME 710 of FIG. 7) via the first network device, a confirmation response (e.g., response 764 of FIG. 7) on another one of the available response time slots. The confirmation response confirms the configuration data associated with the first network device.

FIG. 10 is a block diagram illustrating an example of a computing system 1000, which may be employed by the disclosed systems and techniques for wireless communication devices (e.g., ESLs) securely changing a network device (e.g., an AP). In particular, FIG. 10 illustrates an example of computing system 1000, which can be, for example, any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to” and/or “at least one processor being configured to” indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

### Illustrative Aspects of the Disclosure Include

Aspect 1. A wireless communication device for wireless communication, the wireless communication device comprising: at least one memory; and at least one processor coupled to the at least one memory and configured to: receive, from a first network device of a plurality of network devices, a synchronization message comprising an indication of available response time slots for transmitting one or more unsolicited responses to the first network device; and outputting, for transmission to the first network device, an unsolicited response in one of the available response time slots.

Aspect 2. The wireless communication device of Aspect 1, wherein the wireless communication device is an electronic shelf label (ESL).

Aspect 3. The wireless communication device of any one of Aspects 1 or 2, wherein the first network device is an access point (AP).

Aspect 4. The wireless communication device of any one of Aspects 1 to 3, wherein the synchronization message comprises a bitmap including the indication of the available response time slots.

Aspect 5. The wireless communication device of Aspect 4, wherein the at least one processor is configured to determine the one of the available response time slots to transmit the unsolicited response from the bitmap.

Aspect 6. The wireless communication device of any one of Aspects 1 to 5, wherein the wireless communication device is synchronized with a second network device, and wherein the at least one processor is configured to: determine the wireless communication device is out of communication range of the second network device; and transmit the unsolicited response in one of the available response time slots to the first network device based on determining the wireless communication device is out of communication range of the second network device.

Aspect 7. The wireless communication device of any one of Aspects 1 to 6, wherein the at least one processor is configured to receive, from the first network device, configuration data associated with the first network device, wherein the configuration data associated with the first network device comprises an encrypted key for the first network device.

Aspect 8. The wireless communication device of Aspect 7, wherein the configuration data associated with the first network device further comprises an identifier associated with the first network device, the identifier being based on a group identifier (GID) of a group to which the wireless communication device is assigned and an identifier assigned to the wireless communication device.

Aspect 9. The wireless communication device of any one of Aspects 7 or 8, wherein the at least one processor is configured to decrypt the encrypted key for the first network device to generate a key for the first network device.

Aspect 10. The wireless communication device of Aspect 9, wherein the wireless communication device is synchronized with a second network device, and wherein the at least one processor is configured to: determine the wireless communication device is out of communication range of the second network device; and transmit the unsolicited response in one of the available response time slots to the first network device based on determining the wireless communication device is out of communication range of the second network device.

Aspect 11. The wireless communication device of Aspect 10, wherein the at least one processor is configured to replace a key for the second network device with the key for the first network device.

Aspect 12. The wireless communication device of Aspect 11, wherein the at least one processor is configured to: receive one or more synchronization packets from the first network device, wherein the one or more synchronization packets are encrypted using the key for the first network device; decrypt information from the one or more synchronization packets using the key for the first network device; and synchronize with the first network device using the decrypted information from the one or more synchronization packets.

Aspect 13. The wireless communication device of any one of Aspects 7 to 12, wherein the at least one processor is configured to: output, for transmission to a network entity via the first network device, a confirmation response on another one of the available response time slots, the confirmation response confirming the configuration data associated with the first network device.

Aspect 14. A method of wireless communication performed at a wireless communication device, the method comprising: receiving, by the wireless communication device from a first network device of a plurality of network devices, a synchronization message comprising an indication of available response time slots for transmitting one or more unsolicited responses to the first network device; and transmitting, by the wireless communication device to the first network device, an unsolicited response in one of the available response time slots.

Aspect 15. The method of Aspect 14, wherein the wireless communication device is an electronic shelf label (ESL).

Aspect 16. The method of any one of Aspects 14 or 15, wherein the first network device is an access point (AP).

Aspect 17. The method of any one of Aspects 14 to 16, wherein the synchronization message comprises a bitmap including the indication of the available response time slots.

Aspect 18. The method of Aspect 17, further comprising determining, by the wireless communication device, the one of the available response time slots to transmit the unsolicited response from the bitmap.

Aspect 19. The method of any one of Aspects 14 to 18, wherein the wireless communication device is synchronized with a second network device, and further comprising: determining the wireless communication device is out of communication range of the second network device; and transmitting the unsolicited response in one of the available response time slots to the first network device based on determining the wireless communication device is out of communication range of the second network device.

Aspect 20. The method of any one of Aspects 14 to 19, further comprising receiving, by the wireless communication device from the first network device, configuration data associated with the first network device, wherein the configuration data associated with the first network device comprises an encrypted key for the first network device.

Aspect 21. The method of Aspect 20, wherein the configuration data associated with the first network device further comprises an identifier associated with the first network device, the identifier being based on a group identifier (GID) of a group to which the wireless communication device is assigned and an identifier assigned to the wireless communication device.

Aspect 22. The method of any one of Aspects 20 or 21, further comprising decrypting, by the wireless communication device, the encrypted key for the first network device to generate a key for the first network device.

Aspect 23. The method of Aspect 22, wherein the wireless communication device is synchronized with a second network device, and further comprising: determining the wireless communication device is out of communication range of the second network device; and transmitting the unsolicited response in one of the available response time slots to the first network device based on determining the wireless communication device is out of communication range of the second network device.

Aspect 24. The method of Aspect 23, further comprising replacing, by the wireless communication device, a key for the second network device with the key for the first network device.

Aspect 25. The method of Aspect 24, further comprising: receiving one or more synchronization packets from the first network device, wherein the one or more synchronization packets are encrypted using the key for the first network device; decrypting information from the one or more synchronization packets using the key for the first network device; and synchronizing with the first network device using the decrypted information from the one or more synchronization packets.

Aspect 26. The method of any one of Aspects 20 to 25, further comprising: transmitting, by the wireless communication device to a network entity via the first network device, a confirmation response on another one of the available response time slots, the confirmation response confirming the configuration data associated with the first network device.

Aspect 27. A network device for wireless communication, the network device comprising: at least one memory; and at least one processor coupled to the at least one memory and configured to: output, for transmission to a wireless communication device, a synchronization message comprising an indication of available response time slots for transmitting one or more unsolicited responses to the network device; and receive, from the wireless communication device, an unsolicited response in one of the available response time slots.

Aspect 28. The network device of Aspect 27, wherein the synchronization message comprises a bitmap including the indication of the available response time slots.

Aspect 29. The network device of any one of Aspects 27 or 28, wherein the at least one processor is configured to output, for transmission to the wireless communication device, configuration data associated with the network device, wherein the configuration data associated with the network device comprises an encrypted key for the network device.

Aspect 30. The network device of Aspect 29, wherein the configuration data associated with the network device further comprises an identifier associated with the network device, the identifier being based on a group identifier (GID) of a group to which the wireless communication device is assigned and an identifier assigned to the wireless communication device.

Aspect 31. A method for wireless communications at a network device, the method comprising: transmitting, by the network device to a wireless communication device, a synchronization message comprising an indication of available response time slots for transmitting one or more unsolicited responses to the network device; and receiving, by the network device from the wireless communication device, an unsolicited response in one of the available response time slots.

Aspect 32. The method of Aspect 31, wherein the synchronization message comprises a bitmap including the indication of the available response time slots.

Aspect 33. The method of any one of Aspects 31 or 32, further comprising transmitting, by the network device to the wireless communication device, configuration data associated with the network device, wherein the configuration data associated with the network device comprises an encrypted key for the network device.

Aspect 34. The method of Aspect 33, wherein the configuration data associated with the network device further comprises an identifier associated with the network device, the identifier being based on a group identifier (GID) of a group to which the wireless communication device is assigned and an identifier assigned to the wireless communication device.

Aspect 35. A non-transitory computer-readable storage medium comprising instructions stored thereon which, when executed by at least one processor, causes the at least one processor to perform operations according to any one of Aspects 14 to 26.

Aspect 36. An apparatus for wireless communications, comprising one or more means for performing operations according to any one of Aspects 14 to 26.

Aspect 37. A non-transitory computer-readable storage medium comprising instructions stored thereon which, when executed by at least one processor, causes the at least one processor to perform operations according to any one of Aspects 31 to 34.

Aspect 38. An apparatus for wireless communications, comprising one or more means for performing operations according to any one of Aspects 31 to 34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A wireless communication device for wireless communication, the wireless communication device comprising:
at least one memory; and
at least one processor coupled to the at least one memory and configured to:
receive, from a first network device of a plurality of network devices, a synchronization message comprising an indication of available response time slots for transmitting one or more unsolicited responses to the first network device; and
outputting, for transmission to the first network device, an unsolicited response in one of the available response time slots.

2. The wireless communication device of claim 1, wherein the wireless communication device is an electronic shelf label (ESL).

3. The wireless communication device of claim 1, wherein the first network device is an access point (AP).

4. The wireless communication device of claim 1, wherein the synchronization message comprises a bitmap including the indication of the available response time slots.

5. The wireless communication device of claim 4, wherein the at least one processor is configured to determine the one of the available response time slots to transmit the unsolicited response from the bitmap.

6. The wireless communication device of claim 1, wherein the wireless communication device is synchronized with a second network device, and wherein the at least one processor is configured to:
determine the wireless communication device is out of communication range of the second network device; and
transmit the unsolicited response in one of the available response time slots to the first network device based on determining the wireless communication device is out of communication range of the second network device.

7. The wireless communication device of claim 1, wherein the at least one processor is configured to receive, from the first network device, configuration data associated with the first network device, wherein the configuration data associated with the first network device comprises an encrypted key for the first network device.

8. The wireless communication device of claim 7, wherein the configuration data associated with the first network device further comprises an identifier associated with the first network device, the identifier being based on a group identifier (GID) of a group to which the wireless communication device is assigned and an identifier assigned to the wireless communication device.

9. The wireless communication device of claim 7, wherein the at least one processor is configured to decrypt the encrypted key for the first network device to generate a key for the first network device.

10. The wireless communication device of claim 9, wherein the wireless communication device is synchronized with a second network device, and wherein the at least one processor is configured to:
determine the wireless communication device is out of communication range of the second network device; and
transmit the unsolicited response in one of the available response time slots to the first network device based on determining the wireless communication device is out of communication range of the second network device.

11. The wireless communication device of claim 10, wherein the at least one processor is configured to replace a key for the second network device with the key for the first network device.

12. The wireless communication device of claim 11, wherein the at least one processor is configured to:
receive one or more synchronization packets from the first network device, wherein the one or more synchronization packets are encrypted using the key for the first network device;
decrypt information from the one or more synchronization packets using the key for the first network device; and
synchronize with the first network device using the decrypted information from the one or more synchronization packets.

13. The wireless communication device of claim 7, wherein the at least one processor is configured to:
output, for transmission to a network entity via the first network device, a confirmation response on another one of the available response time slots, the confirmation response confirming the configuration data associated with the first network device.

14. A method of wireless communication performed at a wireless communication device, the method comprising:
receiving, by the wireless communication device from a first network device of a plurality of network devices, a synchronization message comprising an indication of available response time slots for transmitting one or more unsolicited responses to the first network device; and
transmitting, by the wireless communication device to the first network device, an unsolicited response in one of the available response time slots.

15. The method of claim 14, wherein the wireless communication device is an electronic shelf label (ESL).

16. The method of claim 14, wherein the first network device is an access point (AP).

17. The method of claim 14, wherein the synchronization message comprises a bitmap including the indication of the available response time slots.

18. The method of claim 17, further comprising determining, by the wireless communication device, the one of the available response time slots to transmit the unsolicited response from the bitmap.

19. The method of claim 14, wherein the wireless communication device is synchronized with a second network device, and further comprising:
determining the wireless communication device is out of communication range of the second network device; and
transmitting the unsolicited response in one of the available response time slots to the first network device based on determining the wireless communication device is out of communication range of the second network device.

20. The method of claim 14, further comprising receiving, by the wireless communication device from the first network device, configuration data associated with the first network device, wherein the configuration data associated with the first network device comprises an encrypted key for the first network device.

21-30. (canceled)
